(19) United States
(12) Patent Application Publication
(10) Pub. No.: US 2008/0089973 A1
(43) Pub. Date: Apr. 17, 2008

(54) POTTER'S WHEEL

(75) Inventor: Jorge Ernesto Ramos Peart, Saltillo (MX)

Correspondence Address: Glast, Phillips & Murray, P.C, 13355 Noel Road, Suite 2200, Dallas, TX, 75240, US

(73) Assignee: AVENTURAS DEL NORTE SA DE CV, Saltillo (MX)

(21) Appl. No.: 11/870,841

(22) Filed: Oct. 11, 2007

(30) Foreign Application Priority Data
Oct. 13, 2006 (MX) PA/U/2006/000207

(51) Int. Cl. B28B 11/00

(52) U.S. Cl. 425/459

(57) ABSTRACT

A potter's wheel has a shaft supporting a lower rotatable disc for a pedal and an upper rotatable disc supporting clay to be molded. The shaft connects the two discs. The shaft and discs are supported in a support structure made from a peripheral frame. The support structure supports a top platform through which the shaft supporting the upper rotatable disc passes. The upper rotatable disc is substantially elevated above the top platform to avoid the possibility of an operator's hand being caught and injured between the upper rotatable disc and the top platform.

### CLAIM FOR PRIORITY

This application claims the priority of Mexican Patent Application Serial No. PA/u/2006/000207, filed Oct. 13, 2006, and titled “Estructura de torno alfarero con fines didácticos.”

### TECHNICAL FIELD

This disclosure is related to tools and apparatus used for making clay objects by hand. More specifically it refers to a structure for a potter's wheel driven by a pedal.

### BACKGROUND

Today the use of potter's wheels for making objects, utensils and artistic pieces from clay by hand is well known. There are wheels driven by pedals and electric wheels, both for driving a revolving circular platform on which is placed a ball of clay, which is to be molded with the hands in order to give it a specific shape.

Wheels, which are driven by pedals, are generally composed of an axle or vertical shaft that comprises on its upper end a circular revolving disc, and near the lower end it comprises a second circular disc that serves as a pedal that is driven by the feet, the lower end of the axle or shaft rests on axle housing.

The problem with potter's wheels that are driven by pedals is that they are generally designed and constructed by the potters themselves, thus they have no construction pattern and the dimensions of these wheels vary considerably, depending on the needs of each individual potter. For obvious reasons it would be difficult for such a potter's wheel to be operated by a child, due to the strength needed to operated a wheel of adult dimensions; thus these wheels cannot be used for teaching purposes where a child would operate the wheel.

Furthermore, the potter's wheels driven by pedals are generally made of wood and the circular revolving disc where the clay that is to be molded with the hands is placed undergoes wear. Such wear occasionally can damage the pieces or articles that are being molded, and there exists the possibility of the operator getting splinters in his hands, an obvious risk for children.

Another inconvenience with potter's wheels driven by a pedal is that the platform or top of the wheel assembly has an opening through which the axle or shaft passes, so that the revolving upper disc is very close to the platform. If this space is too small, there is a risk that a child's hands could be trapped in the space and injured.

What is needed is a potter's wheel driven by a pedal that can be safely used for teaching and practicing the hand crafting of objects and utensils, as well as artistic pieces made of clay, while at the same time being easily operable for children and novices.

### DRAWINGS

FIG. 1, which is the only drawing, shows a perspective view of the preferred embodiment of the potter's wheel.

### DESCRIPTION

The characteristic details of the potter's wheel here described are clearly shown in the following description and the illustrative drawings which are annexed, and in which the same reference numbers refer to the same parts.

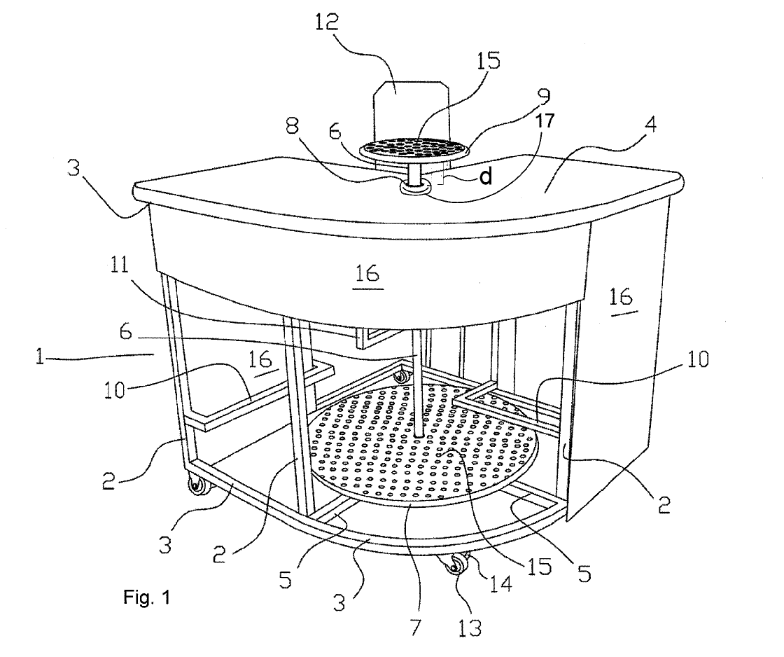

FIG. 1 shows a perspective view of a potter's wheel operated with a pedal. (In this disclosure, “potter's wheel” is used to refer to the entire assembly.) In FIG. 1, the wheel comprises a support structure (1) defined by a peripheral frame made up of vertical posts (2) joined at the top and bottom by peripheral struts (3), A top platform (4) rests on top of structure (1); various horizontal struts (5) project out from the inside ends of the vertical posts (2), meeting at a central point at which there is an axle box (not shown) that houses the bottom end of a rotating shall (6). A first disc (7), preferably made of metal, is affixed to the rotating shaft; the disc acting as a pedal. The shaft (6) projects vertically out passing through a second axle box (not shown) attached at the opening (8) made in the top platform (4). At the top end of the rotating shaft (6), which is projects above the upper platform (4), a second rotatable disc (9), preferably made of metal, of smaller diameter than the first disc (7), is affixed. The upper disc (9) is used to hold the clay to molded on. The second disc (9) is mounted on the shaft (6) substantially elevated above the upper surface of the platform (4) at a distance “d,” where “substantially elevated” refers to a distance that will avoid the possibility of the operator's hands becoming entrapped between the second disc (9) and the top platform (4).

The upper platform (4) preferably comprises a sealing means (17), such as plastic washers or O-rings on the edge as well as on the opening for the shaft (6), to prevent water from filtering into the structure (1).

It may also be observed that internally to structure (1), there may be two supporting cross bars (10, 11) on which the operator may place his or her feet, so that the operator can freely move his or her feet to brake the lower rotatable disc (7).

The frame also preferably comprises a support projection (not shown) on the back side (as shown in FIG. 1) that is vertically placed so that a threaded means (not shown) thereon into which a second threaded means (not shown) may be screwed is affixed to the under side of a seat (12), the seat (12) being adjustable in height depending on the needs of the operator.

The support structure (1) preferably further comprises moveable wheels (13) with brakes (14) on its lower face in order to facilitate moving it around. The front, side and part of the back faces of the structure (1) are covered by covering panels (16) on which diverse publicity may be placed.

The lower (7) and upper (9) rotatable discs preferably have a plastic coating (15) with a rough surface, at least on the lower rotatable disc (7), to promote the grip of the foot to spin and brake the wheel.

Since those skilled in the art can modify the specific embodiments described above, I intend that the claims be interpreted to cover such modifications and equivalents.

I claim:

1. A potter's wheel comprising:
a shaft; the shaft having upper and lower ends;
a first rotatable disc for acting as a pedal;
a second rotatable disc for supporting clay to be molded;
the first rotatable disc connected to the lower end of the shaft;
the second rotatable disc connected to the upper end of the shaft;
a support structure comprising:
a peripheral frame; the frame comprising:
a plurality of vertical posts joined at the top and bottom by peripheral struts;
a lower axle box for housing the lower end of the shaft;
a plurality of horizontal struts; the horizontal struts projecting out from the bottoms of the vertical posts; the horizontal struts connected to the lower axle box;
a top platform supported by the vertical struts;
the top platform comprising:
an opening for the shaft, and,
a second axle box for housing the upper end of the shaft;
the upper end of the shaft being further exposed for the attachment of the second rotatable disc; and,
the second rotatable disc being substantially elevated above the top platform.

2. The potter's wheel of claim 1 where:
the upper and lower rotatable discs are made of a metal; and,
at least the lower rotatable disc has a covering with a rough surface.

3. The potter's wheel of claim 1, where the support structure further comprises wheels to assist moving the potter's wheel.

4. The potter's wheel of claim 1 where the support structure further comprises covering panels.

5. The potter's wheel of claim 1 where the support structure is curved from front to back.

6. The potter's wheel of claim 1 where the top platform has a means for sealing the opening in the top platform to prevent water from entering the support structure.

7. The potter's wheel of claim 1 further comprising an adjustable seat connected to the support structure.
